(19) United States
(12) Patent Application Publication
(10) Pub. No.: US 2022/0242691 A1
(43) Pub. Date: Aug. 4, 2022

(54) Method for Automatic Elevator Dispatching

(71) Applicant: David Sean Kehoe, Jersey City, NJ (US)

(72) Inventor: David Sean Kehoe, Jersey City, NJ (US)

(21) Appl. No.: 17/649,351

(22) Filed: Jan. 29, 2022

Related U.S. Application Data
(60) Provisional application No. 63/144,394, filed on Feb. 1, 2021.

(51) Int. Cl. B66B 1/24

(52) U.S. Cl. CPC B66B 1/2466

(57) ABSTRACT

A method for assigning elevators to specific routes based on zones consisting of contiguous floors, where the destination zone is provided prior to boarding by the first passenger for that zone and by means of one of multiple call buttons or their functional equivalent, and a “next floor” button within the elevator car for requesting a stop at the next available floor.

### CROSS REFERENCE

The present application claims priority to the earlier filed Provisional Application No. 63/144,394, and hereby incorporates subject matter of the provisional application in its entirety.

### BACKGROUND

Traditionally, all the elevators in a building serve all floors. In a building with a single elevator under the control of a simple elevator dispatch system, the elevator car travels like a bus on a bus route: starting out at the lobby, traveling to each floor requested by a button pressed within the elevator and picking up new passengers traveling in the same direction as it passes floors along its way. After the elevator completes it trip by reaching the highest floor requested or to which it is summoned, it repeats the process, often in the reverse direction. When there are multiple elevators, a more intelligent dispatch system determines which elevator should respond to each hallway call so that multiple elevators do not attempt to service the same request.

In buildings with multiple elevators, several techniques have been used to move passengers more efficiently than the “bus on a bus route” model. Very large buildings may use an “elevator bank” system, in which the elevators are segregated into physical lobby areas based on destination floors; these elevators function as if they were isolated elevator systems in separate buildings and require riders to go to a specific elevator bank according to their destination. While this technique reduces lobby congestion, it can also be inefficient because of the lack of sharing of elevators: unless the elevator traffic is equally distributed among the elevator banks, there can be idle elevators in one bank while riders are queuing up in another bank.

Smaller buildings may use a scaled-down version of the elevator bank technique by having a common waiting lobby but assign specific elevators within the elevator bank to service only specific floors. Again, this can create inefficiencies when the demand across the elevators is not equal.

Recently, with the advent of technologies to gather more information about passengers (e.g., having passengers specify their destination floor before boarding, weight sensors to estimate passenger load to detect full elevators), more sophisticated approaches have been developed to optimize carrying passengers between floors. Destination Dispatch is one such methodology as described in U.S. Pat. No. 11,027,943. While recent inventions may further increase the efficiency of elevator operations, they require more involvement by the passenger than the traditional “up” call button and the use of sophisticated technology that may be cost prohibitive to many buildings.

### SUMMARY OF THE INVENTION

The present invention offers improved operational efficiency over the traditional elevator dispatch methodologies without the sophistication required by the Destination Dispatch approach. The present invention assigns elevator routes based on zones—a group of one or more contiguous floors. The use of zones allows a passenger to register their destination before boarding using additional, familiar “up” buttons in the lobby, and without specifying their destination floor until after boarding, Additional passengers traveling to the same destination do not have to register a destination, analogous to arriving at the lobby using a traditional dispatch system and seeing the “up” button has already been pressed.

By knowing the passenger's destination zone, the elevator dispatch system can easily:

1. Group together passengers traveling to the same zone, thus increasing the likelihood that more than one rider will be heading to the same destination and thus reduce duplicate trips by different elevators.

2. Dispatch elevators on short and long trips, with short trips enabling the elevators to return to the lobby faster to reduce passenger wait time and increasing the effective elevator capacity.

In addition, by adding a “Next Floor” button on the inside of the elevator car, a passenger who has boarded the wrong elevator and who wants to abandon a trip or who has missed his floor can easily request to exit the elevator car at the next reachable floor without frantically trying to find the right floor button for the next eligible floor.

### DETAILED DESCRIPTION OF THE INVENTION

Please note:

1. The present invention applies regardless of the number or relative position of the lobby floor(s), which is understood to be the floor at which a majority of the passengers start their elevator trip for subsequent dispersement throughout the building or end their trip at after boarding from other floors. Likewise, when the predominate direction of travel from the lobby is downward (such as when servicing a subterranean structure), the following descriptions are reversed; and when the direction of travel is horizontal, an analogous transformation of the description applies.

2. The present invention is described as implemented for “up” traffic from the lobby, but it could be applied to other scenarios. When activated only for “up” traffic, “down” traffic continues to be controlled using other elevator dispatch methods.

3. The term “button” is used as a shorthand for any method of registering a request for a trip or a stop at a particular floor and is not limited to mechanical buttons. “Hallway buttons” refers to call buttons located on floors other than the lobby.

4. For ease of understanding, the description assumes a building with a single ground floor lobby and a plurality of upper floors.

The invention comprises the following parts and/or methods, none of which is individually novel unless noted. Each part and/or method may be partially or in whole employed as a part of a complete method for existing as well as for novel purposes:

1. An automatic elevator dispatch system that responds to calls for service from the lobby or hallway call buttons and floor buttons within the elevator car.

2. A novel call panel in the lobby that has at least two “up” buttons (one per zone), and novel elevator car direction indicators in the lobby that either have one “up” indicator for each zone or other ability to indicate the assigned zone, with one set of indicators per elevator. These are in place of the single “up” button panels and direction indicators in common use today.

3. A novel button labelled “Next”, “Next Floor”, a symbol implying the same, or other nomenclature on the panel within one or more of the elevator cars.

The present invention can be activated manually, or by any combination of time of day, day of week, season, levels of requests for service, current performance statistics, or other criteria.

When the present invention is not activated, presses on one of the multiple “up” buttons causes all of the “up” buttons on that panel (and any panel providing duplicate function) to light and the elevator system to respond as if there was a single “up” button and it was pressed. When the “up” direction indicator light illuminates, all of the “up” lights would illuminate. Thus, other than the number of buttons and indicators lit, the visual signals would act as they would without the present invention. Likewise, audio indications would also act as they would without the present invention.

When the present invention is activated, the multiple “up” buttons act independently to indicate calls for service from the lobby to some floor in the indicated zone. Similarly, the multiple lobby indicator lights act independently to indicate the assignment of a particular elevator car to travel from the lobby to floors in the indicated zone(s). Audio indications within the elevator car would announce the destination zones by zone name or range of floors as required by the client, law, or regulation.

Zones are contiguous floors designated within the elevator dispatch system and indicated (by zone name and/or the range of floors) on the signage. All floors must be assigned to a zone, and some floors may be assigned to two zones. With the appropriate call panel and indicator lights—such as using electronic display screens, the composition of zones can be altered as frequently as each trip; however, too frequent change of zone definitions may be confusing for the repeat passenger, such as an employee or resident of the building, and end up being counter-productive. Alternatively and unlike the elevator bank methodology, zones could be evolved (along with any signage) to tune the system for better performance based on experience.

Individual elevators are assigned to a zone only for the duration of the trip; once the trip is completed, the elevator awaits assignment to the same or a new zone.

When one of multiple “up” buttons in the lobby is pressed, an available elevator will be assigned to the selected zone. If there are other passengers in the lobby destined for that zone, they may choose to board the same elevator or wait until that elevator has departed and press the appropriate call button again. Once an elevator is assigned to one or more zones and unless it services an “up” call from a floor along the way, the panel within the elevator only accepts calls for stops in the assigned zones; if the elevator does respond to a hallway call during its trip, the elevator will accept calls for floor from within the elevator car for stops ahead in the direction the elevator is traveling.

If there are multiple “up” buttons pressed in the lobby, the second responding elevator will be assigned to the second zone requested, and so forth based on the order in which the buttons were pressed. If an elevator is assigned to multiple zones, it will be assigned to the next button pressed and the buttons for any other of its zones subsequently pressed. Through the use of the direction indicators (which illuminate as soon as an elevator destined for the lobby is assigned to a zone), passengers in the lobby can begin queuing for an appropriate elevator.

If an elevator is in the lobby with its doors open and it has not yet received a zone assignment via a press on a lobby or hallway call panel, pressing a floor button within the elevator will assigned the elevator to a zone containing that floor.

1. A methodology for assigning elevators to service calls based on zones having one or more contiguous floors.

2. A methodology for assigning elevators to service calls as said in claim 1 comprising two or more buttons (or the functional equivalent of buttons) in the lobby for registering a passenger's intended destination zone.

3. A methodology for assigning elevators to service calls as said in claim 2 comprising one or more direction indicators per zone per elevator to indicate the zone assignment of each elevator.

4. A button or its functional equivalent on the call panel within the elevator car for signaling to the dispatch system to stop the elevator car at the next floor at which the elevator can arrive without exceeding its usual speed of de-acceleration.
